(19) United States
(12) Patent Application Publication
(10) Pub. No.: US 2004/0125171 A1
(43) Pub. Date: Jul. 1, 2004

(54) Packaging structure of an inkjet print head chip and method for making the same

(76) Inventors: Fa-Yuan Hsu, Hsinchu Hsien (TW); Je-Ping Hu, Hsinchu Hsien (TW)

Correspondence Address: BIRCH STEWART KOLASCH & BIRCH, PO BOX 747, FALLS CHURCH, VA, 22040-0747, US

(21) Appl. No.: 10/420,694

(22) Filed: Apr. 23, 2003

(30) Foreign Application Priority Data
Dec. 27, 2002 (TW) 091137777

(51) Int. Cl. B41J 2/14

(52) U.S. Cl. 347/50

(57) ABSTRACT

A packaging structure for inkjet print head chips and the method for manufacturing them are disclosed. An inkjet print head chip with several contact nodes on its surface is mounted onto a substrate through chip bonding to form a packaging structure. Since the contact nodes are not limited to the border of the chip, the number of pins on the chip can be increased. The packaging method can be combined with the semiconductor processes to lower the cost. Moreover, the chip mounting packaging structure has the advantages of self-alignment and high reliability.

### BACKGROUND OF THE INVENTION

1. Field of Invention

The invention relates to a chip packaging structure and the method for making the same. More particularly, it relates to a packaging structure of an inkjet print head chip and the corresponding manufacturing method.

2. Related Art

The inkjet print head chip is a key component in an inkjet printer. The conventional semiconductor process can be employed to lower its manufacturing cost. Most of the packaging structures used for inkjet print head chips utilize the semiconductor lead bonding technique.

The printing technology of inkjet printers has been making tremendous progress in recent years. As users request for better printing quality and higher resolution, there have been higher demands in the reliability, nozzle density, and element sizes of the inkjet print head chips. Therefore, the conditions for print head chip packaging and bonding technique become more stringent. The conventional lead bonding method combines the pads of the chip with pads on the substrate by alignment and embossing. This requires the use of the inner lead bonding equipment in the semiconductor technology. During the packaging, the pads of the print head chip are first precisely aligned with the pins of the substrate. The pins and the pins are then welded together by embossing. The welding area is filled with an adhesive to increase the reliability. As the precision and difficulty involved in this process are fairly high, the process conditions are likely to affect the quality of the packaging structure.

Due to the limits of the lead bonding process, the density of the pads on the print head chip has an upper bound. In addition to homogeneous controls of both temperature and pressure, the lead bonding further requires precision alignments that will increase the packaging cost.

### SUMMARY OF THE INVENTION

In view of the foregoing, the invention provides a packaging structure for inkjet print head chips and a method for making the same. The print head chip with several contact nodes on its surface is combined with a substrate by chip mounting to form a packaging structure. In comparison with the prior art, the contact nodes are not restricted to the border of the chip in the invention. Therefore, the number of I/O pins on the chip can be largely increased. The invention can incorporates semiconductor processes to lower the cost. The structure also has the advantages of self-alignment and high reliability.

According to the disclosed technology, the inkjet print head chip packaging structure contains: a chip, which has a plurality of fluid channels for a fluid to pass through and a plurality of conductive contact nodes on its surface; a substrate, which has a plurality of pads corresponding to the plurality of conductive contact nodes, each pad being connected to the associated conductive contact node on the chip surface, so that the chip is mounted on the surface of the substrate and the fluid supply region on the substrate is in fluid communications with the chip; and an adhesive material, which fills the junction area of the chip and the substrate.

The conductive contact nodes have to be higher than the surface for the chip to combine with the substrate. The contact nodes can be formed by combining the metal pads and solder balls on the chip surface. The adhesive material is a thermally cured polymer.

The disclosed method includes the steps of: providing a chip with a plurality of fluid channels for a fluid to pass through, the surface of the chip having a plurality of conductive contact nodes; forming a plurality of pads on the surface of a substrate with a plurality of fluid supply regions; aligning the conductive contact nodes on the chip surface with the pads on the substrate surface so that the chip is mounted onto the substrate surface and the fluid supply regions on the substrate are in fluid communications with the fluid channels on the chip; filling the adhesive material in the junction area of the chip and the substrate, the adhesive material stopping at the edge of the fluid supply region due to the boundary effects.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the first embodiment;

FIGS. 2 to 4 are schematic views of the flowchart of the invention;

FIG. 5 is a schematic view of the inkjet print head chip with two rows of solder balls; and

FIG. 6 is a schematic view of the disclosed three-color chip packaging.

### DETAILED DESCRIPTION OF THE INVENTION

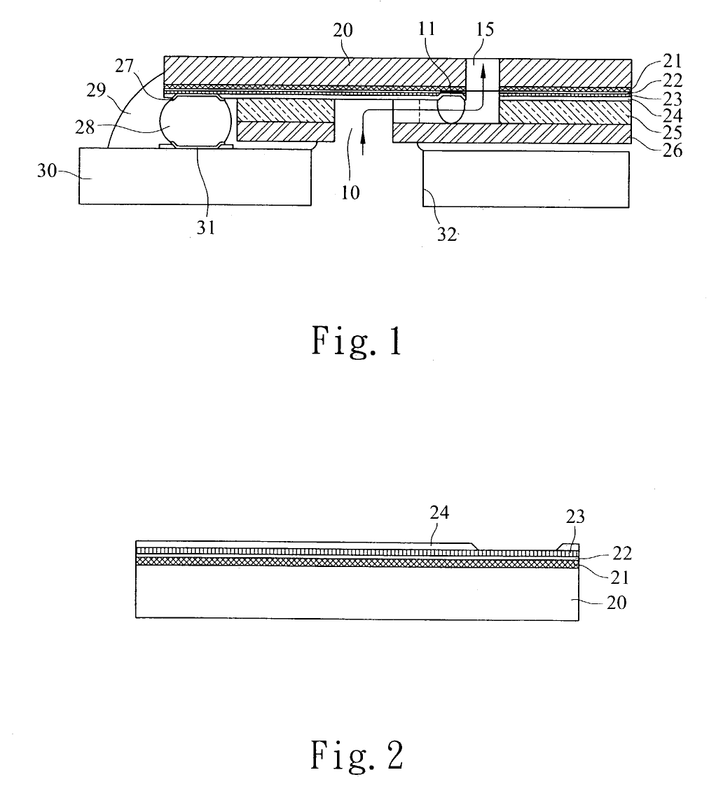

With reference to FIG. 1, the inkjet print head chip packaging structure according to a first embodiment of the invention is comprised of the combination of a chip and a substrate. The surface of the chip 20 is stacked with a thermal barrier layer 21, a heating layer 22, a conductive layer 23, an insulating layer 24, and several conductive metal pads 27. A solder ball 28 is formed on top of each metal pad 27. The chip 20 has several fluid channels 10 through the chip 20 for a fluid to pass. The fluid channels 10 go up to the top surface of the chip 20 to form several nozzles 15. The structure of the fluid channels is formed by stacking dry films 25 and bottom plates 26 on the insulating layer 24. The fluid channel contains a heater 11 to produce thermal bubbles. The surface of the substrate 30 has several pads 31 corresponding to the solder balls. Each pad 31 is connected to the associated solder ball 28 on the chip surface 20 so that the chip 20 is mounted onto the substrate 30. Several fluid supply regions 32 on the substrate 20 are in fluid communications with the fluid channels 10 on the chip. An adhesive material 29 fills in the junction area of the chip 20 and the substrate 30.

The fluid supply regions 32 on the substrate provide the fluid to the chip 20. After filling the adhesive material 29 in the junction area of the chip 20 and the substrate 30, it will stop due to the boundary effects of the fluid supply regions 32, avoiding the adhesive overflow.

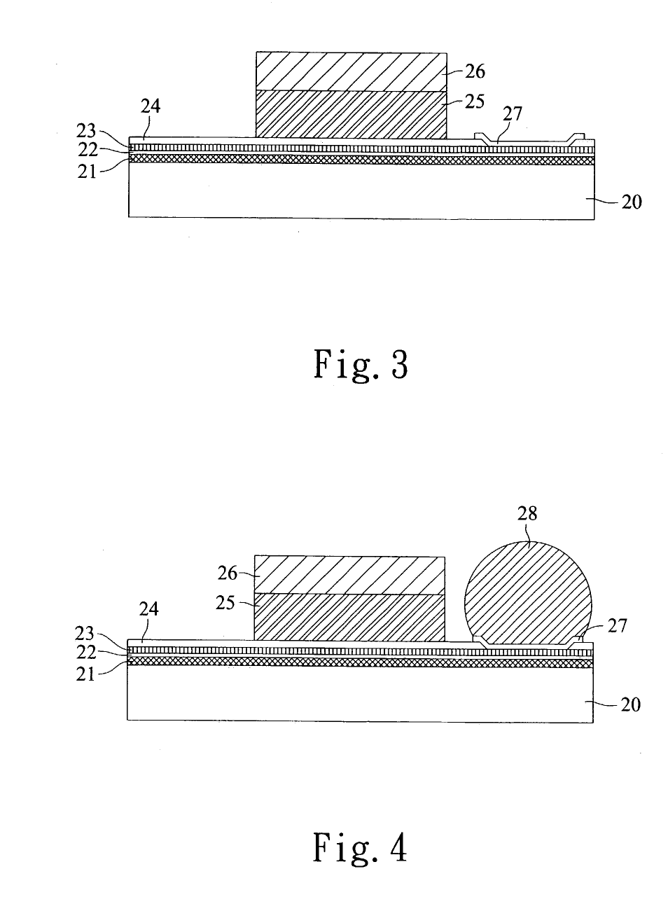

To explain the disclosed method, please refer to FIGS. 2 to 4. As shown in FIG. 2, the chip surface is formed in order with a thermal barrier layer 21, a heating layer 22, a conductive layer 23, and an insulating layer 24 using semiconductor techniques. The insulating layer 24 has several openings connecting to the conductive layer 23. As shown in FIG. 3, several conductive metal pads 27 are formed at the openings of the insulating layer 24. A dry film 25 is further formed as the barrier layer and as the structure body of the fluid channels. The surface of the dry film is formed with a bottom plate 26 with openings. As shown in FIG. 4, solder balls 28 are formed on the metal pads 31. Each metal pad 31 is deposited with a soldering metal block. The soldering metal block will form a solder ball 28 under an appropriate temperature. This then completes the chip part. By combining the chip 20 and the substrate 30, one obtains an inkjet print head packaging structure as shown in FIG. 1. Part of the substrate 30 is formed with several metal pads 31 on its surface. The substrate 30 has fluid supply regions 32. The solder ball 28 on the surface of the chip 20 is aligned with the pad 31 on the surface of the substrate 30 so that the chip 20 is mounted on the substrate 30. The fluid supply regions 32 of the substrate 30 are connected to the fluid channels 10 of the chip 20. Finally, an adhesive material 29 is filled in the junction area of the chip 20 and the substrate 30. The adhesive material 29 stops at the edge of the field supply regions 32 due to the boundary effects. In addition to the adhesive and protection functions, the adhesive material 29 is also ink resistant.

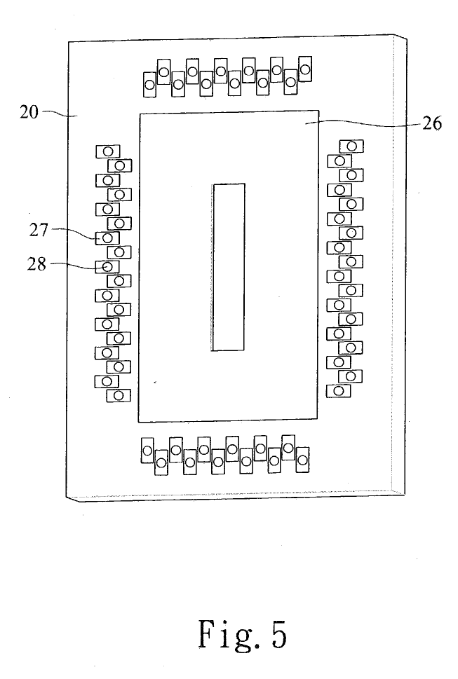

In particular, the solder balls have to be higher than the surface structure of the chip in order to combine with the substrate. The metal pads are in contact with the barrier layer on the chip surface and the conductive layer above the barrier layer. The material of the barrier layer is selected from Ti, Cr and their alloys. The material of the conductive layer is selected from Cu, Ni, and their alloys. The solder ball is a Sn—Pb alloy formed by half-tone printing, electroplating or non-electroplating methods. The adhesive material is a polymer material. The adhesive material is mobile. It fills into the junction between the chip and the substrate through the capillary effect and stops at the edge of the fluid supply regions due to the boundary effects. The contact nodes of the chip mounting are not limited to the border of the chip. The number of chip pins can be effectively increased by making multiple rows of arrayed contact nodes. FIG. 5 shows an inkjet print head chip with two rows of solder balls. Two rows of solder balls 28 and metal pads27 are formed on the chip 20. The fluid channels are formed at the place covered by the bottom plate 26. This completes a high-density packaging.

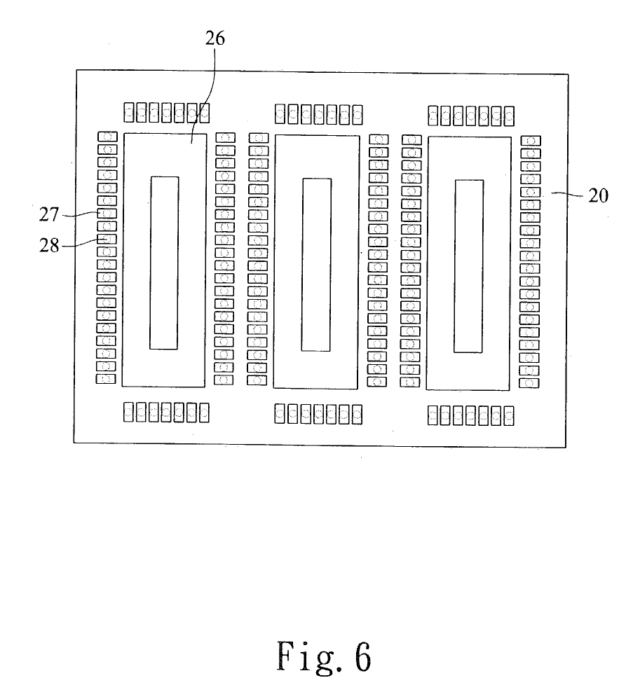

Moreover, the invention can have a setup with multiple rows, as shown in FIG. 6. The structure in the drawing is an arrayed packaging structure with three independent fluid supplies. It has a chip 20 with several rows of solder balls 28 and metal pads 27. When the chip is mounted onto the substrate, the adhesive material will fill via the fluid supply region boundary, forming three independent fluid supply regions. This configuration can be used for the three-color chip packaging used in high nozzle density cases.

Certain variations would be apparent to those skilled in the art, which variations are considered within the spirit and scope of the claimed invention.

What is claimed is:

1. An inkjet print head chip packaging structure, comprising:
a chip, which has a plurality of fluid channels for a fluid to pass through, the surface of the chip having a plurality of conductive contact nodes;
a substrate, whose surface has a plurality of pads corresponding to the conductive contact nodes, each of the pads being connected to the associated conductive contact node to mount the chip on the substrate surface and the plurality of fluid supply regions of the substrate thereby providing the fluid to flow through the fluid channels in the chip; and
an adhesive material, which fills the junction area between the chip surface and the substrate surface.

2. The packaging structure of claim 1, wherein the conductive contact nodes form an arrayed conductive contact nodes with more than one row.

3. The packaging structure of claim 1, wherein each of the fluid channels has a heater to produce thermal bubbles that drive the fluid.

4. The packaging structure of claim 1, wherein the conductive contact nodes are higher than the junction surface structure of the chip and the substrate.

5. The packaging structure of claim 1, wherein the adhesive material is a thermally cured polymer.

6. The packaging structure of claim 1, wherein the conductive contact node is formed by combining a metal pad on the chip surface and the associated solder ball.

7. The packaging structure of claim 6, wherein the solder ball is made using a method selected from half-tone printing, electroplating, and non-electroplating.

8. The packaging structure of claim 6, wherein the material of the solder ball is an Sn—Pb alloy.

9. The packaging structure of claim 1, wherein the chip surface further contains a barrier and a conductive layer above the barrier layer, the top of the conductive layer being connected to the conductive contact node.

10. The packaging structure of claim 9, wherein the material of the barrier layer is selected from the group consisting of Ti, Cr, and their alloys.

11. The packaging structure of claim 9, wherein the material of the conductive layer is selected from the group consisting of Cu, Ni, and their alloys.

12. A method for manufacturing an inkjet print head chip packaging, comprising the steps of:
providing a chip with a plurality of fluid channels for the fluid to flow through, the chip surface having a plurality of conductive contact nodes;
forming a plurality of pads on a substrate surface, the substrate having a plurality of fluid supply regions;
aligning and combining each of the conductive contact nodes on the chip surface with the associated pad on the substrate surface, so that the chip is mounted on the substrate surface and the fluid supply regions in the substrate are in fluid communications with the fluid channels in the chip; and
filling an adhesive material in the junction area of the chip and the substrate, the adhesive material stopping at the border of each of the fluid supply regions due to the boundary effects.

13. The method of claim 12, wherein the conductive contact nodes form an arrayed conductive contact nodes with more than one row.

14. The method of claim 12, wherein the conductive contact nodes are higher than the junction surface structure of the chip and the substrate.

15. The method of claim 12, wherein the adhesive material is a thermally cured polymer.

16. The method of claim 12, wherein the step of filling an adhesive material in the junction area of the chip and the substrate fills the mobile fluid in the junction area using the capillary effect.

17. The method of claim 12, wherein the conductive contact node is formed by combining a metal pad on the chip surface and the associated solder ball.

18. The method of claim 17, wherein the solder ball is made using a method selected from half-tone printing, electroplating, and non-electroplating.

19. The method of claim 17, wherein the material of the solder ball is an Sn—Pb alloy.

20. The method of claim 12, wherein the chip surface further contains a barrier and a conductive layer above the barrier layer, the top of the conductive layer being connected to the conductive contact node.

21. The method of claim 20, wherein the material of the barrier layer is selected from the group consisting of Ti, Cr, and their alloys.

22. The method of claim 20, wherein the material of the conductive layer is selected from the group consisting of Cu, Ni, and their alloys.
